(19) United States
(12) Patent Application Publication
(10) Pub. No.: US 2009/0249365 A1
(43) Pub. Date: Oct. 1, 2009

(54) METHOD FOR GOAL BASED MODALITY

(75) Inventors: Samar Choudhary, Morrisville, NC (US); Richard Adam King, Cary, NC (US); Vijay Pandiarajan, Apex, NC (US); Niraj Dinesh Patel, Apex, NC (US); Shikha Srivastava, Cary, NC (US)

Correspondence Address: ZILKA-KOTAB, PC- IBMS, P.O. BOX 721120, SAN JOSE, CA, 95172-1120, US

(73) Assignee: International Business Machines Corporation, Armonk, NY (US)

(21) Appl. No.: 12/060,217

(22) Filed: Mar. 31, 2008

(51) Int. Cl. G06F 9/46

(52) U.S. Cl. 719/320

(57) ABSTRACT

In one general embodiment, a method includes, from within a single application running under control of an operating system, receiving a request to launch a first task, outputting a first tabbed page having a first tab and information relating to the first task, receiving a request to launch a second task, outputting a second tabbed page having a second tab and information relating to the second task, launching a sub goal modal to the first task, suspending access to the first task pending resolution of the sub goal, displaying information about the sub goal upon receiving user selection of the first tab during suspension of the first task, and allowing access to the second task during suspension of the first task.

### BACKGROUND

The present invention relates to software, and more particularly, this invention relates to launching modal windows in web based software applications.

In user interface design, a modal window refers to a child window which requires a user to interact with the window before die user is able to continue to operate a parent application that launched the child window. Modal windows are often called modal dialogs because the window is often used to display a dialog box. Modal windows are commonly used in graphic user interlace (GUI) systems to absorb user awareness and to display emergency states.

Currently, modality is enforced on an entire current application. This limits the user to an interaction model that enforces modality to the entire application scope.

### SUMMARY

In one general embodiment, a method includes from within a single application running under control of an operating system, receiving a request to launch a first task, outputting a first tabbed page having a first tab and information relating to the first task, receiving a request to launch a second task, outputting a second tabbed page having a second tab and information relating to the second task, launching a sub goal modal to the first task, suspending access to the first task pending resolution of the sub goal, displaying information about the sub goal upon receiving user selection of the first tab during suspension of the first task, and allowing access to the second task during suspension of the first task.

Other aspects, advantages and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWING

FIG. 1 shows a method for goal based modality, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that; as used in the specification and the appended claims, the singular forms “a,” “an” and “the” include plural referents unless otherwise specified.

In one general embodiment, a method includes, from within a single application running under control of an operating system, receiving a request to launch a first task, outputting a first tabbed page having a first tab and information relating to the first task, receiving a request to launch a second task, outputting a second tabbed page having a second tab and information relating to the second task, launching a sub goal modal to the first task, suspending access to the first task pending resolution of the sub goal, displaying information about the sub goal upon receiving user selection of the first tab during suspension of the first task, and allowing access to the second task during suspension of the first task.

More illustrative information will now be set forth regarding various optional architectures and features with which the foregoing framework may or may not be implemented, per die desires of the user. It should be strongly noted that the following information is set forth for illustrative purposes and should not be construed as limiting in any manner. Any of the following features may be optionally incorporated with or without the exclusion of other features described.

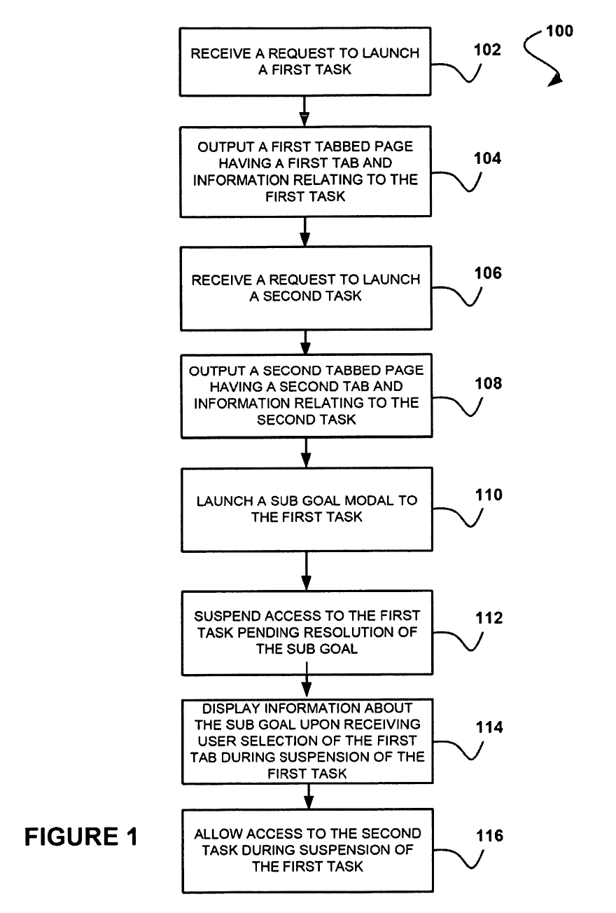

FIG. 1 shows a method 100 for goal based modality, in accordance with one embodiment. As shown, a request to launch a first task. See operation 102. Additionally, a first tabbed page having a first tab and information relating to the first task is outputted. See operation 104. Further, a request to launch a second task, is received. See operation 106.

Still yet, a second tabbed page having a second tab and information relating to the second task is outputted. See operation 108. Furthermore, a sub goal modal to the first task is launched. See operation 110. In addition, access to the first task pending resolution of the sub goal is suspended. See operation 112.

Moreover, information about the sub goal is displayed upon receiving user selection of the first tab during suspension of the first task. See operation 114. As an option, page bread crumbs may be utilized to provide a visual notification to the user about the sub goal. Also, access is allowed to the second task during suspension of the first task. See operation 116. Furthermore, all operations described, and illustrated in the context of FIG. 1 may be implemented from within a single application running under control of an operating system. It should be noted that, in one embodiment, the first and second tasks may be multiple instances of the same task. Additionally, although the method 100 was described in terms of tabs to representing launched tasks, any number of techniques may be used to represent such tasks (e.g. programmatic calls, etc.)

Using this method 100, a goal may be achieved by performing several, user interface tasks. For example, while working in a tabbed based environment, a user may launch a task that will be modal with respect to the task front which it was launched. While this modal task is active, the user may still interact with other tasks and this modal task may only block tasks from which it was launched. When the modal task is completed or dismissed, the parent task may be rendered.

Furthermore, in one embodiment, this technique may be implemented in a tasking environment including multiple instances of the same task, potentially in different states. In this case, each task, may have multiple instances and modality may be achieved for each instance of the goal.

Moreover, a main task, from which a sub task (i.e. a modal, task) is launched, may hold a reference to the sub task and sub task may hold a reference to the main task. Thus, parent-child reference sets may exist. The parent main task may always wrapper the modal, sub task. Therefore, whenever a user requests to focus on the task (e.g. by clicking on a tabs or by some programmatic call, etc.), an appropriate task may be rendered based on a check that will be made to determine if the task has a reference set for a modal task. It should be noted that the modality may apply to an arbitrary number of inter-related tasks that constitute a goal.

As an example, a user may launch two tasks. The first task may include creating a system template where a wizard will define a system template for creating a virtualized system. In this example, the second task may include a storage management task or a task to manage external storage systems.

While working on the first task, the user may launch a modal sub task. In this case, the sub task would need to be completed before the user may continue with the first task. The modal sub task launched then takes over content area of the first task and displays the content rendered by the sub task. The page bread crumbs stack may then provide a visual notification to the user about this modal sub task launch.

The user may then switch to the second task to look up some storage data that will help complete modal sub task on the first task. When the user switches back to the first task, the modal sub task is displayed since the modal sub task was not yet completed. The user may then complete the modal sub task, and the first task will be displayed such that the user may continue with first task wizard.

In another environment, such as the web based portal console, there are multiple products installed on the same glass. This leads to multiple independent user interface (UI) flow graphs that constitute different goals. The goals may include UI tasks from single or multiple products. For example, to achieve a particular goal such as “Creating System Template” a dependent goal of “Uploading OS Image” needs to be completed at a specific point in the UI flow of the main goal. Furthermore, a user may be working on multiple main goals and each of these goals might have a need to launch a sub goal that needs to be completed before continuing with the parent goal. Thus, using the aforementioned techniques, a user may have the ability to launch a sub goal modal to a main goal, the ability to switch between the different main goals while one of the main goals is blocked by a modal sub goal, and the ability to automatically return to the main goal on dismissal of a modal sub goal.

Additionally, multiple goals may be blocked by different modal sub goals. Further, a modal sub goal may launch another modal sub goal. Also, using these techniques improves the usability of a GUI by providing a single representation of the entire modal goal as a single tab stating main goal, clearing bread crumbs on page titles showing the path to modal sub goal, and encapsulating the modal sub goal within main goal tab. Still yet, any page may be made modal by specifying modal attribute

It should be noted that, the invention can take the form of an embodiment containing both hardware and software elements. In one embodiment, the invention may be implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

While various embodiments have been described above, it should be understood that they have been presented by way of example only, and not limitation. Thus, the breadth and scope of a preferred embodiment should, not be limited by any of the above-described exemplary embodiments, but should be defined only in accordance with the following claims and their equivalents.

1. A method, comprising:
from within a single application running under control of an operating system:
receiving a request to launch a first task;
outputting a first tabbed page having a first tab and information relating to the first task to a display device;
receiving a request to launch a second task;
outputting a second tabbed page having a second tab and information relating to the second task to the display device;
launching a sub goal modal to the first task;
suspending access to the first task pending resolution of the sub goal;
displaying information about the sub goal upon receiving user selection of the first tab during suspension of the first task; and
allowing access to the second task during suspension of the first task.
